(19) United States
(12) Patent Application Publication
(10) Pub. No.: US 2007/0056448 A1
(43) Pub. Date: Mar. 15, 2007

(54) Popcorn maker

(76) Inventor: Colin M. Kernan, Hingham, MA (US)

Correspondence Address: STEVEN A. GARNER, ESQ.;CONAIR CORPORATION, ONE CUMMINGS POINT ROAD, STAMFORD, CT, 06902, US

(21) Appl. No.: 11/513,694

(22) Filed: Aug. 31, 2006

Related U.S. Application Data
(60) Provisional application No. 60/714,169, filed on Sep. 2, 2005.

(51) Int. Cl. A23L 1/18

(52) U.S. Cl. 99/323.5

(57) ABSTRACT

A popcorn-making device comprises a bowl attached to a popping plate assembly and a base. The popping plate assembly can be used to hold and heat corn kernels so that they may be popped. A stirring rod rotates on the heat plate in order keep the kernels moving throughout the popping process. This enables the popcorn maker to require less oil, for a healthier alternative to microwave or other types of popcorn. The popping plate assembly can have a safety interlocking mechanism to enable a user to safely and easily remove and reattach the popping plate assembly to and from the base for washing purposes. The device can have a heater safety mechanism to automatically shut the heater when the popping plate assembly is disengaged from the base. At any time that the popping plate assembly is not properly engaged with the base, the heater will be shut off and the device will not operate.

### CROSS-REFERENCE TO RELATED APPLICATIONS

This application claims priority to U.S. Provisional Patent Application Ser. No. 60/714,169 filed on Sep. 2, 2005, incorporated herein by reference in its entirety.

### BACKGROUND OF THE INVENTION

1. Field of the Invention

The present invention relates to a popcorn maker, and more particularly, to a popcorn maker having a bowl and popping plate that are removable for cleaning purposes, as well as a popcorn maker that enables a user to control the type and amount of corn, oil and flavorings.

2. Description of Related Art

Popcorn-making devices of various types are known in the art and are used for popping kernels of corn into popcorn. There are various methods for heating the corn kernels, with various ingredients added in the popcorn-making process. However, other known devices do not enable a user to easily remove the components of the device so that they may be washed. Other known devices also do not have an efficient safety mechanism that prevents the device from operating when the components are reassembled after washing. They also are not conducive for using minimal amounts of oil for a healthier alternative, as well as for enabling a user to mix various ingredients in with the popcorn.

There exists a need for a popcorn-making device that enables a user to easily remove and wash the various parts of the popcorn-making device, along with a safety device that automatically prevents operation of the device when device is not properly assembled. There is also a need for a popcorn-making device that requires a minimal amount of oil for healthier popcorn.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a popcorn-making device having a bowl attached to a popping plate assembly and a base. A popping plate assembly can be used to hold and heat the kernels so that they may be popped. A stirring rod rotates on the heat plate in order keep the kernels moving throughout the popping process. This enables the popcorn maker to require less oil, for a healthier alternative to microwave or other types of popcorn.

The popping plate assembly can have a safety interlocking mechanism to enable a user to safely and easily remove and reattach the popping plate assembly to and from the base. This enables a user to easily remove the popping plate assembly for washing and reattachment to the base. A locking lever can be squeezed to provide a force against a spring so that a tab can be rotated away from a locking position for engagement and disengagement between the popping plate assembly and the base. The tab will fit securely into a safety interlock and ensure that the popping plate mechanism is secured to the base.

The popcorn-making device can have a heater safety mechanism to automatically shut the heater when the popping plate assembly is disengaged from the base. Located on the base can be an opening with a post. This post, when depressed by a column on the popping plate assembly, can complete a circuit for the heater and thermostat. At any time that the popping plate assembly is not properly engaged with the base, the heater will automatically be shut off.

### BRIEF DESCRIPTION OF THE DRAWINGS

FIG. 1 is a perspective view of a popcorn-making device in accordance with a preferred embodiment of the present invention.

FIG. 2 is an exploded view of a popcorn-making device in accordance with a preferred embodiment of the present invention.

FIG. 3 is partial perspective view of the bottom of a popping plate assembly in accordance with a preferred embodiment of the present invention.

### DESCRIPTION OF THE PREFERRED EMBODIMENT

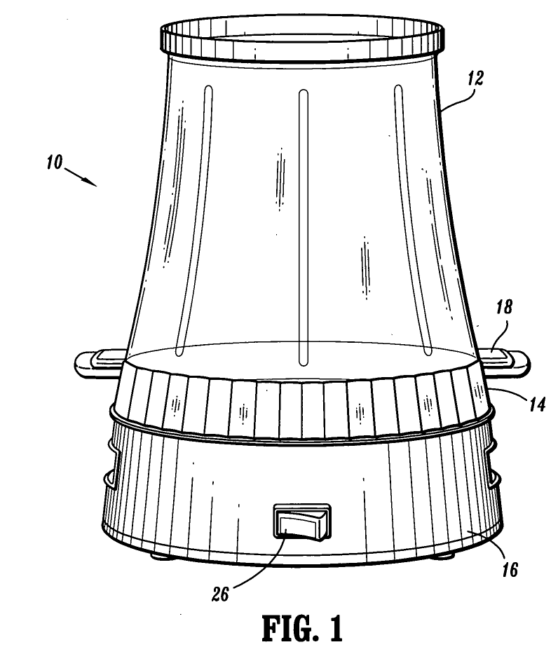

Referring to FIG. 1, there is shown a popcorn-making device 10 according to the preferred embodiment of the present invention that comprises a bowl 12 attached to a popping plate assembly 14 and a base 16. The base 16 is adapted to rest on a generally flat surface such as a counter or tabletop.

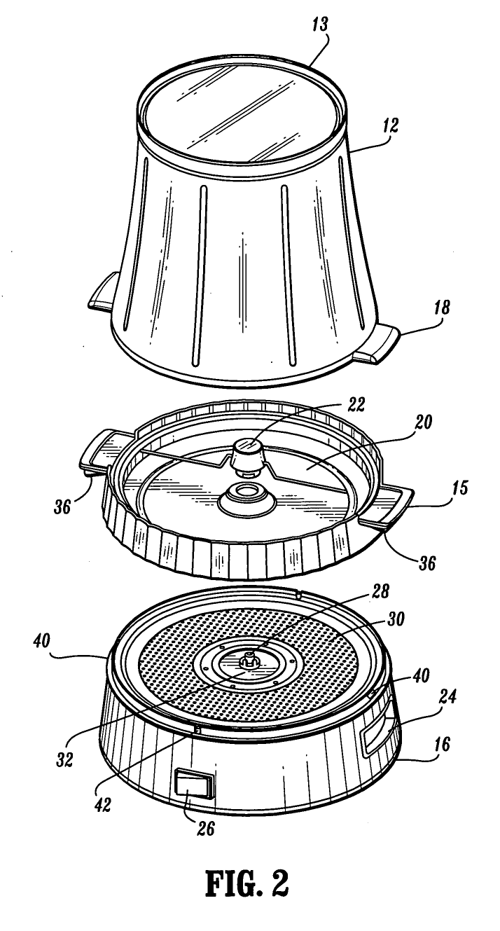

FIG. 2 shows an exploded view of the popcorn-making device 10. The bowl 12 is used to contain the corn kernels while they are being popped and to act as a serving bowl for the popped kernels during consumption. The bowl 12 can be made from plastic or any other material sufficient to hold the popcorn and withstand the heat necessary to pop the kernels. The top end of the bowl 12 has a raised flange 13. This raised flange 13 assists in preventing excessive heat and condensation from affecting the counter or tabletop. Preferably, the bowl 12 is transparent so that a user may see the kernels as they are being popped. However, the bowl 12 can also be opaque or non-transparent. The bowl 12 can have one or more bowl handles 18 to enable a user to easily hold the bowl 12.

The popping plate assembly 14 can be used to hold and heat the kernels so that they may be popped. The popping plate assembly 14 can be generally cylindrical shaped and have one or more popping plate handles 15. A heat plate 20 can be heated up to a temperature sufficient to pop the corn kernels. The corn kernels, oil and other ingredients are placed on the heat plate 20. The heat plate 20 can be made of aluminum or any other heat-conductive material. A stirring rod 22 rotates on the heat plate 20 in order keep the kernels moving throughout the popping process. This enables the popcorn maker to require less oil, for a healthier alternative to microwave or other types of popcorn.

The base 16 can have a generally cylindrical shape with two or more handles 24 on the sides. The handles 24 can be in the shape of a well or any other shape to enable a user to easily lift the popcorn-making device 10. The base 16 can have a power-supply cord (not shown) to provide power to the device 10. An on/off switch 26 enables the user to turn the popcorn-maker on or off. The on/off switch 26 can be in the form of a toggle switch, a button or any other type of device known to those skilled in the art.

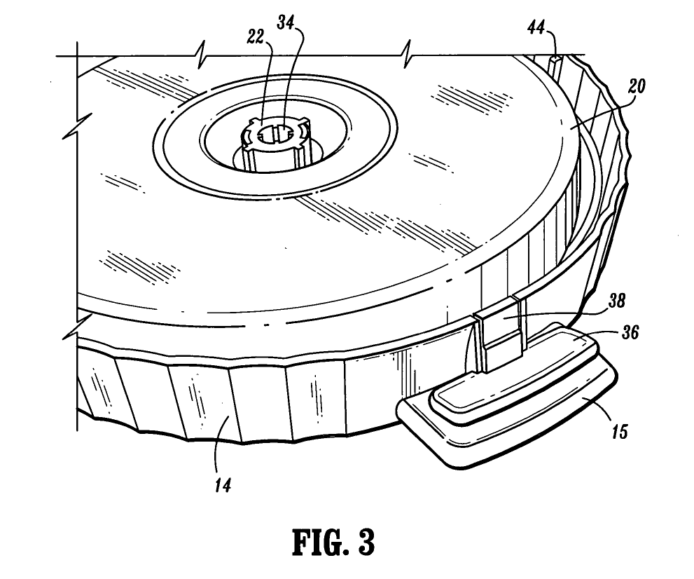

Within the base 16 is a motor (not shown) that can rotate a rotation shaft 28. The end of the rotation shaft 28 can fit within the stirring rod 22 to cause the stirring rod 22 to rotate and move the corn kernels and other ingredients. FIG. 3 shows a portion of the bottom of the popping plate assembly 14. In the center of the heat plate 20 is the bottom of the stirring rod 22 with a groove 34 in the middle. The top of the rotation shaft 28 can fit within the groove 34 to enable the rotation shaft 28 to turn the stirring rod 22. The rotation shaft 28 and the groove 34 can have a complementary shape to prevent slippage between the rotation shaft 28 and groove 34.

A heater (not shown) within the base can heat the heat plate 20 to a temperature sufficient to pop the corn kernels. A thermostat (not shown) within the base measures the temperature of the heat plate 20 via a contact plate 32. This contact plate 32 can be spring biased against the bottom of the heat plate 20 to enable the contact plate 32 to maintain full contact with bottom of the heat plate at all times. This will provide the thermostat with a more accurate temperature reading. Preferably, contact plate 32 is disk shaped. A heater shield 30 at the top of the base 16 can protect a user from the heater when hot. The heater shield 30 can be perforated to enable the maximum amount of heat to radiate to the heat plate 20.

The popping plate assembly 14 can have a safety interlocking mechanism to enable a user to safely and easily remove and reattach the popping plate assembly 14 to and from the base 16. This enables a user to easily remove the popping plate assembly 14 for washing and reattachment to the base 16. Connected to the popping plate handles 15 can be one or more plate locking levers 36. Each plate locking lever 36 can have a tab 38. The locking lever 36 can be depressed to rotate the tab 38 into or out of a safety interlock 40 located on the base 16. The safety interlock 40 can be in the form of a well or hole to receive the tab 38. The tab 38 can be spring biased to maintain the tab 38 in the locking position. The locking lever 36 can be squeezed to provide a force against the spring so that the tab 38 can be rotated away from the locking position for engagement and disengagement between the popping plate assembly 14 and the base 16. The tab 38 will fit securely into the safety interlock 40 and ensure that the popping plate mechanism 14 is secured to the base 16.

The popcorn-making device 10 can have a heater safety mechanism to automatically shut the heater when the popping plate assembly 14 is disengaged from the base 16. Located on the base 16 can be an opening with a post 42. This post 42, when depressed, can complete a circuit for the heater and thermostat. The post 42 can be spring biased away from the circuit completing condition. Located on the inside wall of the popping plate assembly 14 can be a column 44. When the plate popping mechanism 14 is correctly secured to the base 16, the column 44 will come into contact with and depress the post 42. This will complete the circuit and enable the heater to operate. At any time that the popping plate assembly 14 is not properly engaged with the base 16, the heater will be shut off.

In order to operate the popcorn-making device 10, a user must properly lock the popping plate assembly 14 to the base. The locking levers 36 are gripped toward the handles 15 of the popping plate assembly 14, which will open the lock. The popping plate assembly 14 is then placed on the base 16. The popping plate handles 15 are placed in a position to where they are centered just above the handles 24 on the base 16. Once the locking levers 36 are released, the popping plate assembly 14 is locked to the base 16.

The user can then add corn kernels, oil and other ingredients to the popping plate assembly 14. The inverted bowl 12 is then placed on top of the popping plate assembly 14. The power cord is plugged into a standard electrical outlet and the power switch 26 is turned to ON. The stirring rod 22 will then begin to rotate and cooking will begin.

When the popcorn has finished popping, the locking levers 36 are grasped against the popping plate handles 15 and the bowl handles 18 to unlock the popping plate assembly 14. The bowl 12 and popping plate assembly 14 are lifted together from the base 16. The bowl 12 and popping plate assembly 14 are then turned over and the bottom of the bowl 12 is placed on a flat surface. The popping plate assembly 14 is lifted off the bowl 12 by the popping plate handles 15 and returned to the base. The bowl full of popcorn is then consumed.

While a preferred embodiment of the invention has been herein disclosed and described, it is understood that various modifications can be made without departing from the scope of the invention.

What is claimed is:

1. A popcorn maker comprising:
a base adapted to rest on a generally flat surface;
a plate assembly supported by said base and selectively removable from said base, said plate assembly adapted to hold and heat corn kernels;
a bowl selectively removable from said plate assembly and adapted to contain said corn kernels.

2. A popcorn maker according to claim 1, wherein
said plate assembly further comprises a stirring rod adapted to rotate about a central axis to move kernels during the popping process.

3. A popcorn maker according to claim 1, wherein
said plate assembly further comprises at least one handle.

4. A popcorn maker according to claim 3, wherein
said plate assembly further comprises an interlock mechanism to enable a user to selectively remove and reattach said plate assembly to and from said base.

5. A popcorn maker according to claim 4, wherein
said interlock mechanism comprises
a lever attached to said plate assembly;
a tab connected to said lever; and
a well located in said base to receive said tab,
whereby said tab is biased inward to lock said plate assembly to said base when said lever is released and said plate assembly is properly positioned on said base.

6. A popcorn maker according to claim 1, further comprising
a heater safety mechanism adapted to automatically shut power to a heater when said plate assembly is disengaged from said base.

7. A popcorn maker according to claim 6, wherein
said heater safety mechanism comprises
a post located on said base; and
a column located on said plate assembly,
whereby said post is spring biased away from completing an electronic circuit with said heater and whereby said spring bias is overcome by said column when said plate assembly is properly positioned on said base, thereby completing said electronic circuit to provide power to said heater.

8. A popcorn maker according to claim 1, wherein
said bowl has a raised flange around the end opposite said plate assembly.

9. A popcorn maker according to claim 1, wherein
said bowl is transparent.

10. A popcorn maker according to claim 1, wherein
said base further comprises a switch to provide power to a heater.
